(19) United States
(12) Patent Application Publication
(10) Pub. No.: US 2014/0349916 A1
(43) Pub. Date: Nov. 27, 2014

(54) LOW VOC CLEANER

(71) Applicant: Amrep, Inc., Atlanta, GA (US)

(72) Inventor: Paul L. Bolden, Fernandina Beach, FL (US)

(73) Assignee: Amrep, Inc., Atlanta, GA (US)

(21) Appl. No.: 14/286,101

(22) Filed: May 23, 2014

Related U.S. Application Data
(60) Provisional application No. 61/827,090, filed on May 24, 2013.

(51) Int. Cl. C11D 7/50

(52) U.S. Cl. CPC C11D 7/5027; C11D 7/5022
USPC 510/505

(57) ABSTRACT

A cleaner composition with improved cleaning of hydrophobic contaminants typically found on used brake assemblies and parts, including one or more low vapor pressure hydrocarbon solvents, one or more exempted volatile organic compounds, and a non-exempt volatile organic compound.

### CROSS REFERENCE TO RELATED APPLICATIONS

The present application claims the benefit of priority from U.S. Provisional Application No. 61/827,090, filed May 24, 2013, which is incorporated herein by reference.

### BACKGROUND OF THE INVENTION

Presently, the California Air Resource Board (“CARB”) limits the Volatile Organic Compound (“VOC”) content in a California automotive brake parts cleaner to a maximum of 10% VOC under state regulations. The Ozone Transport Commission (“OTC”) has adopted the 10% VOC limit in the OTC Model Rule effective Jan. 1, 2014. The Lake Michigan Air Directors Consortium (“LADCO”) states and the OTC states each review & refer to the OTC Model Rule as the basis of state legislative regulation change. The OTC & LADCO states will be set to begin the inclusion of the revised OTC Model Rule (which adopts the current CARB VOC restrictions) at the end of 2013. In addition Utah has proposed an effective date of Sep. 1, 2014 to adopt the 10% VOC standard for brake cleaners. Canada is also in the process of a revision to follow the 10% brake cleaner VOC limit in their regulations.

The only solvents that were acceptable for use in brake parts cleaners were those listed as exempt by the California Air Resource Board. These included a category entitled “Low Vapor Pressure” solvents (vapor pressure less than 0.1 mm Hg). Only Acetone was acceptable for use in formulating California brake parts cleaners based on cost and the rate of evaporation. Currently, California brake parts cleaners consist of 87% to 90% Acetone (a CARB Exempt Solvent) and 10% of a 100% VOC Hydrocarbon Solvent. Since acetone is a polar solvent, it will not wet or clean hydrophobic substances. This results in very little, if any, removal of brake fluid, oil, grease, asphalt, or rubber contaminates that are typically found on the parts of an automotive brake assembly.

A purpose of the invention is to offer an alternative to the 87%-90% Acetone 10% VOC brake parts cleaner presently being sold and used in California with improved cleaning of hydrophobic contaminants typically found on used brake assemblies and parts.

### DETAILED DESCRIPTION OF THE INVENTION

Embodiments of the invention may be a liquid which may include a hydrocarbon and/or hydrocarbon based solvent which is categorized as a 100% VOC, an exempted VOC and a Low Vapor Pressure (“LVP”) VOC.

Some embodiments of the invention may further include a compressed gas, such as carbon dioxide, nitrogen or compressed air, and/or other compressed gases as a propellant.

For the purposes of the invention the LVP VOCs described herein meet California's definition of an LVP hydrocarbon solvent as defined as follows:
(98) “LVP VOC” means a chemical “compound” or “mixture” that contains at least one carbon atom and meets one of the following:
(A) has a vapor pressure less than 0.1 mm Hg at 20° C., as determined by ARB Method 310; and/or
(B) is a chemical “compound” with more than 12 carbon atoms, or a chemical “mixture” comprised solely of “compounds” with more than 12 carbon atoms, as verified by formulation data, and the vapor pressure and boiling point are unknown; and/or
(C) is a chemical “compound” with a boiling point greater than 216° C., as determined by ARB Method 310; and/or
(D) is the weight percent of a chemical “mixture” that boils above 216° C., as determined by ARB Method 310 as defined in the California Consumer Products Regulations, Subchapter 8.5, Article 2, 94508, (a), (98), (A)(B)(C)(D).

For the purposes of the definition of LVP VOC, chemical “compound” means a molecule of definite chemical formula and isomeric structure, and chemical “mixture” means a substance comprised of two or more chemical “compounds”.

With respect to inclusion of an exempted VOCs as described herein (such as acetone), California Consumer Products Regulations note that exempt VOCs (or carbon-containing chemicals that are not considered VOCs) include: carbon monoxide, carbon dioxide, carbonic acid, metallic carbides or carbonates, and ammonium carbonate, and the following:
(A) methane, methylene chloride (dichloromethane), 1,1,1-trichloroethane (methyl chloroform), trichlorofluoromethane (CFC-11), dichlorodifluoromethane (CFC-12), 1,1,2-trichloro-1,2,2-trifluoroethane (CFC-113), 1,2-dichloro-1,1,2,2-tetrafluoroethane (CFC-114), chloropentafluoroethane (CFC-115), chlorodifluoromethane (HCFC-22), 1,1,1-trifluoro-2,2-dichloroethane (HCFC-123), 1,1-dichloro-1-fluoroethane (HCFC-141b), 1-chloro-1,1-difluoroethane (HCFC-142b), 2-chloro-1,1,1,2-tetrafluoroethane (HCFC-124), trifluoromethane (HFC-23), 1,1,2,2-tetrafluoroethane (HFC-134), 1,1,1,2-tetrafluoroethane (HFC-134a), pentafluoroethane (HFC-125), 1,1,1-trifluoroethane (HFC-143a), 1,1-difluoroethane (HFC-152a), ethoxy-nonafluorobutane (HFE 7200), cyclic, branched, or linear completely methylated siloxanes;
also included are the following classes of perfluorocarbons: cyclic, branched, or linear, completely fluorinated alkanes, cyclic, branched, or linear, completely fluorinated ethers with no unsaturations, cyclic, branched, or linear, completely fluorinated tertiary amines with no unsaturations and sulfur-containing perfluorocarbons with no unsaturations and with the sulfur bonds to carbon and fluorine; and
(B), the following low-reactive organic compounds which have been exempted by the U.S. EPA: acetone, ethane, methyl acetate, parachlorobenzotrifluoride (1-chloro-4-trifluoromethyl benzene) and perchloroethylene (tetrachloroethylene).

Preferred embodiments of the invention may include:
0% to 10% of a hydrocarbon or hydrocarbon based solvent which is categorized as a 100% VOC,
0% to 97% of an exempt VOC as listed in the California Consumer Products Regulations, Subchapter 8.5, Article 2, 94508, (a), (151)(B), such as acetone, or a similarly exempt VOC,
0% to 97% of an exempt VOC as listed in the California Consumer Products Regulations, Subchapter 8.5, Article 2, 94508, (a), (151)(B), such as 1-chloro-4-trifluoromethyl benzene (Parachlorobenzotrifluoride); and
0% to 97% of an LVP VOC hydrocarbon solvent having a vapor pressure that is less than 0.1 mm Hg @20° C. or has more than 12 carbon atoms or has a boiling greater than 216° C. as defined by ARB Method 310 or is the weight percent of a chemical mixture that boils above 216° C. as defined by ARB Method 310 as defined in the California Consumer Products Regulations, Subchapter 8.5, Article 2, 94508, (a), (98), (A)(B)(C)(D).

These preferred embodiments may optionally include 3% to 10% of a compressed gas, such as carbon dioxide or nitrogen, as a propellant.

One preferred embodiment of the invention may include: 20% to 45% of an LVP hydrocarbon solvent, 50% to 80% acetone and 0% to 10% heptane. This preferred embodiment may further include 3% to 10% carbon dioxide as an optional propellant.

An exemplary embodiment of the invention may include about 25% of an LVP hydrocarbon solvent, about 65% acetone and about 10% heptane. This exemplary embodiment may further include 5% carbon dioxide as an optional propellant, by reducing the acetone content to about 60%.

All percentages described herein are in terms of percentage by weight of the total composition.

The chemical components in the embodiments of the invention, except for the propellant gas, are solvents with no chemical reactions between them. The solvents may be combined in any order in a mixing tank and blended until a substantially homogeneous mixture of the compounds is made.

For bulk packaging of the liquid composition embodiments of the invention, the compound is blended as described above. A finished sample of the blended compound is then sent to Quality Control to insure that it meets product specifications. If the sample is approved, the bulk mix may be pumped to the liquid line filler station where containers, such as gallon pails, and/or larger drums and containers are filled to the desired volume and sealed. Then the containers may be labelled and/or placed on pallets.

For an aerosol canister packaging of the embodiments of the invention including liquid composition and a compressed gas propellant, the liquid solvents are first blended as described previously. A finished sample of the blended liquid compound is then sent to Quality Control to insure that it meets product specifications. If the sample is approved, the bulk mix may be pumped to the aerosol line filler station where aerosol cans are filled with the liquid composition to a desired weight. The aerosol can with the liquid composition may then proceed down the production line to a station where a valve assembly is placed in the aerosol can; the aerosol can may then proceed to a propellant gas house where it may either be under-the-cupped pressurized and crimped or crimped and pressure-filled with a compressed gas through the valve. Then the can may travel through a weight-checker device to insure the aerosol can contains the minimum fill weight. The assembled aerosol can containing the liquid composition and the compressed gas may then travel through a 130° F. water bath to insure that the can is properly sealed and is not over pressurized. The aerosol can proceeds down the line where a cap may be installed. The aerosol can is labelled and an extension tube, if required, is attached. The finished cans may be boxed, sealed and/or loaded on a pallet.

### Testing

TABLE 2 further provides test results for embodiments of the invention, as described in samples A1305026-003 and A1305026-004¹, in comparison to conventional brake cleaner compositions as described in samples A1305026-001, A1305026-002 and A1305026-005. The compositions of the samples are shown in TABLE 1 below:

TABLE 1
Test Samples

| | CO₂ | Heptane | Acetone | Methanol | LVP 170 |
|---|---|---|---|---|---|
| Test Sample # | Content | Content | Content | Content | Content |
| A1305026-001¹ | 8% | 10% | 82% | — | — |
| A1305026-002² | 10% | 25% | 45% | 20% | — |
| A1305026-003¹ | 8% | 10% | 57% | — | 25% |
| A1305026-004¹ | 8% | 10% | 45% | — | 37% |
| A1305026-005² | 5% | 45% | 50% | — | — |

NOTES:
¹is a 50 States Compliant Composition,
²is a 49 States Compliant Composition.

LVP 170, is an LVP VOC exempt hydrocarbon solvent as described previously in this specification.

The cleaning efficiency test was performed by first cleaning and drying the 3″×5″×0.05″ blank aluminum alloy test coupons in an oven at 70°±2° C. for 20 minutes. The test coupons are then cooled to room temperature (about 15 minutes) and each weighed (0.0001 g tolerance). The actual weight of each test coupon is recorded as the Coupon Weight.

One side of each test coupon is coated with a heavy undercoating material (e.g., Dupli-Color Rubberized Undercoat, Product #UC 101 Undercoating), and let to sit for one minute and then dried in an oven at 70°±2° C. for 20 minutes. The test coupons are then cooled to room temperature (about 15 minutes) and each weighed again (0.0001 g tolerance). The weight of each test coupon is again recorded with the coating as the Coated Coupon Weight.

Each coated test coupon is then hung in a vertical position, and the extension tubes are removed from the sample spray containers and seated firmly into the actuator opening for each sample spray container. The extension tubes are blown out by triggering the spray actuator on the sample spray containers with a few short blasts.

For each sample spray container, the coated side of one coated test coupon is sprayed for 10 seconds from a distance of 8 to 10 inches. For spray cans with domed bottoms, the actuator opening must be aligned with the manufacturer's mark, which indicates the location of the interior dip tube curl, prior to spraying.

The test coupons are allowed to dry on an absorbent material, such as a paper towel, for one minute to remove any liquid which pools at the bottom of the test coupon. The test coupons are then dried in an oven at 70°±2° C. for 20 minutes. The test coupons are then cooled to room temperature (about 15 minutes) and each weighed again (0.0001 g tolerance). The weight of each test coupon is again recorded with the coating as the Final Coating Weight.

For each test coupon, the Coupon Weight is subtracted from the Coated Coupon Weight to determine the Initial Coating Weight. Then for each test coupon, the Final Coating Weight is subtracted from the Coated Coupon Weight to determine the Coating Removed weight. Finally the Coating Removed weight is divided by the Initial Coating Weight and multiplies by 100 to determine the Percent Coating Removed, or Cleaning Efficiency, for each sample spray container.

TABLE 2
Analysis Test Results

| | | | | Net | Total | Cleaning |
|---|---|---|---|---|---|---|
| Test Sample # | Description | Product # | Manufacturer | Weight | Volume | Efficiency |
| A1305026-001 | Brakleen Brake | 5059 | CRC | 14 oz | 445 ml | 2.94% |
| | Parts Cleaner | | | | | |
| A1305026-002 | Gunk Brake | M715 | RSC | 14 oz | 470 ml | 5.98% |
| | Parts Cleaner | | | | | |
| A1305026-003 | Ultra-Low | 730-4-25 | AMREP | 14 oz | 465 ml | 40.2% |
| | VOC Brake | | | | | |
| | Parts Cleaner | | | | | |
| A1305026-004 | Ultra-Low | 730-04-37 | AMREP | 14 oz | 465 ml | 41.1% |
| | VOC Brake | | | | | |
| | Parts Cleaner | | | | | |
| A1305026-005 | Next Dimension | 73220 | AMREP | 14 oz | 505 ml | 65.1% |
| | Brake and | | | | | |
| | Parts Cleaner | | | | | |
| A1305026-005 | Next Dimension | 73220 | AMREP | 14 oz | 505 ml | 61.7% |
| (Duplicate) | Brake and | | | | | |
| | Parts Cleaner | | | | | |

All samples tested were non-chlorinated compositions.

The results in Table 2 show a high cleaning efficiency for the low VOC cleaners (samples #3 and 4) in embodiments of the invention.

Although the present invention has been described with reference to preferred embodiments, people skilled in the art will recognize that changes may be made in form and detail without departing from the scope of the invention.

What we claim is:

1. A cleaner composition comprising:
20% to 45% by weight of a low vapor pressure hydrocarbon solvent;
50% to 80% by weight acetone; and
0% to 10% by weight heptane.

2. The cleaner composition of claim 1, further comprising:
about 25% by weight of a low vapor pressure hydrocarbon solvent;
about 65% by weight acetone; and
about 10% by weight heptane.

3. The cleaner composition of claim 1, further comprising 3% to 10% by weight carbon dioxide.

4. The cleaner composition of claim 3, further comprising:
about 25% by weight of a low vapor pressure hydrocarbon solvent;
about 60% by weight acetone;
about 10% by weight heptane; and
about 5% by weight carbon dioxide.

5. A cleaner composition comprising:
20% to 45% by weight of one or more low vapor pressure hydrocarbon solvents;
50% to 80% by weight of one or more exempted volatile organic compounds; and
0% to 10% by weight of a non-exempt volatile organic compound.

6. The cleaner composition of claim 5, further comprising:
about 25% by weight of one or more low vapor pressure hydrocarbon solvents;
about 65% by weight of one or more exempted Volatile Organic Compounds; and
about 10% by weight of a non-exempt volatile organic compound.

7. The cleaner composition of claim 5, further comprising 3% to 10% by weight of at least one compressed gas selected from the list including: carbon dioxide, nitrogen and air.

8. The cleaner composition of claim 7, further comprising:
about 25% by weight of one or more low vapor pressure hydrocarbon solvents;
about 60% by weight of one or more exempted volatile organic compounds; and
about 10% by weight of a non-exempt volatile organic compound; and
about 5% by weight of at least one compressed gas selected from the list including: carbon dioxide, nitrogen and air.
